(19) United States
(12) Patent Application Publication
(10) Pub. No.: US 2011/0221875 A1
(43) Pub. Date: Sep. 15, 2011

(54) THREE-DIMENSIONAL IMAGE DISPLAY APPARATUS AND IMAGE PROCESSING APPARATUS

(76) Inventors: Yuki Iwanaka, Yokohama-shi (JP); Masahiro Baba, Yokohama-shi (JP); Kenichi Shimoyama, Tokyo (JP); Ryusuke Hirai, Tokyo (JP)

(21) Appl. No.: 12/885,845

(22) Filed: Sep. 20, 2010

(30) Foreign Application Priority Data
Mar. 11, 2010 (JP) 2010-055104

(51) Int. Cl. H04N 13/04; G06T 15/00

(52) U.S. Cl. 348/54; 345/419; 348/E13.075

(57) ABSTRACT

According to one embodiment, a three-dimensional image display apparatus according to the present embodiments includes an acquisition unit, a selection unit, a generation unit, a display unit. The acquisition unit is configured to acquire attribute information related to attribute of one or more images to be displayed. The selection unit is configured to set parameter information based on the attribute information to control 3D effect for displaying the images and the parameter information includes at least parallax. The generation unit is configured to generate the images adjusted the 3D effect in accordance with the parameter information. The display unit is configured to display the adjusted images.

### CROSS-REFERENCE TO RELATED APPLICATIONS

This application is based upon and claims the benefit of priority from Japanese Patent Application No. 2010-055104, filed Mar. 11, 2010; the entire contents of which are incorporated herein by reference.

### FIELD

Embodiments described herein relate generally to a three-dimensional image display apparatus and an image processing apparatus.

### BACKGROUND

An apparatus and a three-dimensional (3D) display for reproducing a 3D image using binocular parallax provided by two two-dimensional images have been developed. The 3D image is formed to the direction of depth from the screen being reference plane. Known systems for viewing 3D images on a 3D display can be classified into a viewer system that requires a viewer which a user directly looks into or a viewer mounted on the user's head, a with-glasses system that requires a pair of special glasses for a user to wear to display different images respectively to each eye, and the without-glasses system that does not require glasses. Recently, this system is employed for showing 3D motion pictures.

The depth perception that arises in viewing 3D images is brought by a difference between images from different points of view. An binocular parallax and convergence are the typical cues for the depth perception. Binocular parallax is a difference between information obtained from each eye. When an object is observed, an image projected on retinas is displaced from an actual point of fixation. As the difference in relative distance (parallax) corresponds to a depth of the object, the binocular parallax can be converted into depth information. Convergence is orientation of the eyes to cross lines of sight to an object that the eyes are viewing. As the degree of orientation corresponds to the distance to the object, depth perception can be achieved.

An observer who observes images with considerable occurrence of images perceived in front of the display screen, or observes images on a 3D display for a long time sometimes complains of eyestrain. One of the major causes of such eyestrain is mismatch in vision systems and 3D effects. In normal viewing, convergence and an adjustment point are always fixed on one object. An adjustment means to focus on an object. However, while 3D images are being viewed, convergence is made on a 3D object but an adjustment point is fixed on the display screen. As a result, a problem that convergence brought by vision systems mismatches the distance information based on the adjustment is caused by displaying 3D images. The mismatch of 3D effects and vision systems necessitates consideration for vision systems when creating and displaying 3D image content.

A technique for displaying 3D images with appropriate amount of 3D reaches on various sizes of display screen. Such a technique can be achieved by setting a parallax and adjusting a 3D effect based on display apparatus information (a screen size, a visual range) and information concerning shooting setting of a stereocamera (a distance between lenses of stereocameras and a distance from the stereocamera and to a cross point) (see, for example, Japanese Patent No. 3978392).

### BRIEF DESCRIPTION OF THE DRAWINGS

FIG. 1 is an exemplary diagram of an image display apparatus according to a first embodiment.

FIGS. 2A, 2B and 2C show an example of tables stored in a storage unit.

FIG. 3 is a chart showing an example of normalization.

FIGS. 4A and 4B are graphs showing an example of parallax adjustment.

FIG. 5 is an exemplary diagram of an image processing apparatus according to a first embodiment.

### DETAILED DESCRIPTION

In general, according to one embodiment, a three-dimensional (3D) image display apparatus according to the present embodiments includes an acquisition unit, a selection unit, a generation unit, a display unit. The acquisition unit is configured to acquire attribute information related to attribute of one or more images to be displayed. The selection unit is configured to set parameter information based on the attribute information to control 3D effect for displaying the images and the parameter information include at least parallax. The generation unit is configured to generate the images adjusted the 3D effect in accordance with the parameter information. The display unit is configured to display the adjusted images.

Referring to the drawings, the embodiments will be described. The same reference numerals will be given to the same elements and processes to avoid redundant explanation.

Either the with-glass system or the without-glasses system and so on can be adopted for a 3D image display apparatus according to the embodiments described herein, as long as the apparatus is 3D-display-capable. A time-divisional system or a space-divisional system can also be adopted. In the embodiments described below, an example of binocular display for 3D images in a frame sequential time-division system requiring wearing a pair of glasses will be described. Time-divisional system may be employed either a field sequential or a frame sequential.

### First Embodiment

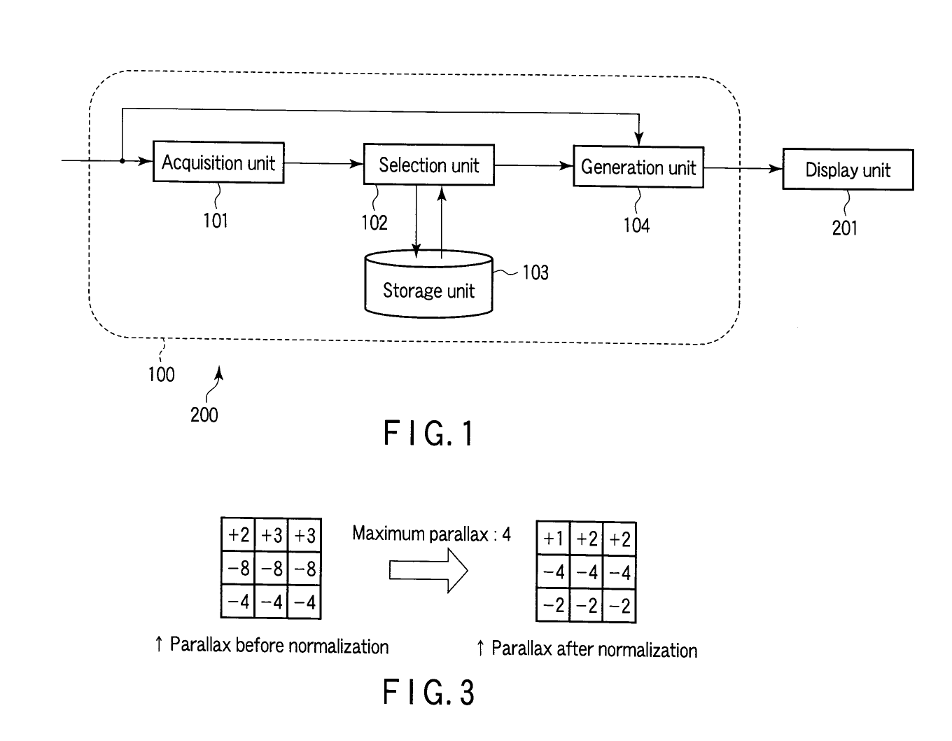

FIG. 1 is a block diagram of a display apparatus 200 according to the first embodiment. Images may be supplied in a variety of ways. For example, images may be supplied via a tuner, or by reading information stored on an optical disc.

The display apparatus 200 includes an image processing unit 100 and a display unit 201. Images to be input to the display apparatus 200 include various image content, such as television program content sent through television broadcast and image content distributed from the Internet, etc. In the present embodiment, information related to a program is input with an image to be displayed. The following embodiment will describe the case of inputting EPG (Electric Program Guide) that is embedded in VBI (Vertical Blanking Interval). Information related to a television program is not limited to those but may be a G-code, program information obtainable from the Internet, or an electronic fingerprint.

The display unit 201 outputs image content as 3D images. The display unit 201 can display not only 3D images but also two-dimensional (2D) images. The display unit 201 displays images generated by a generation unit 104.

The image processing unit 100 includes an acquisition unit 101 configured to obtain attribute information of an image to be displayed from image content, a selection unit 102 configured to set parameter information to control a 3D effect for displaying images based on the attribute information, a storage unit 103 configured to store parameter information, and a generation unit 104 configured to generate images for the image content with a 3D effect that is adjusted according to the parameter information.

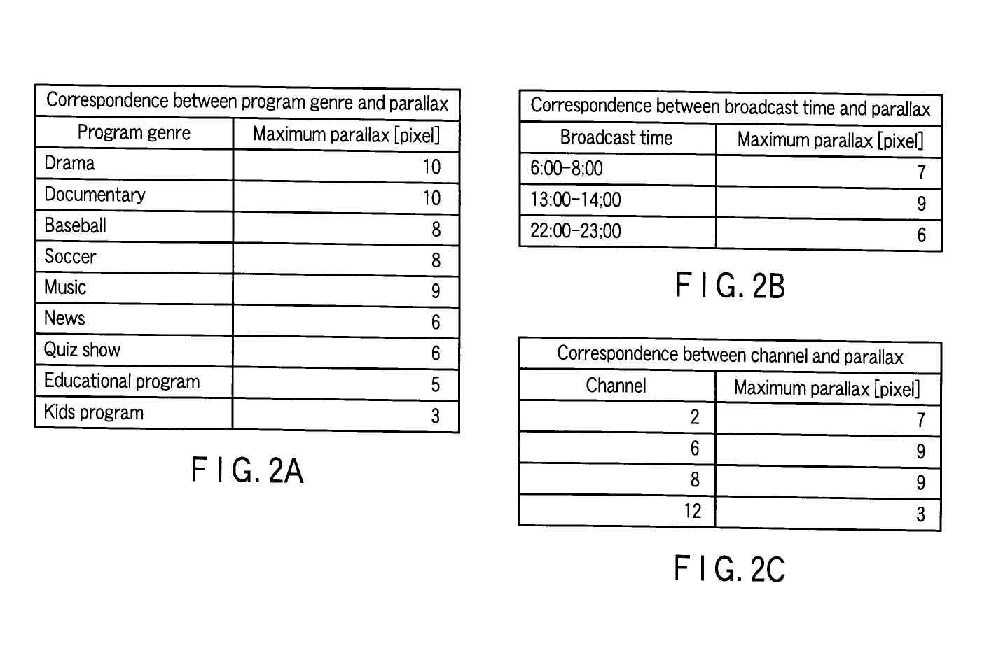

When the acquisition unit 105 acquires image content and a broadcast receive signal including EPG, it extracts the EPG from the broadcast receive signal to obtain attribute information about a program, for example, a program genre, a broadcast time, a channel, casts, keywords, etc. The acquisition unit 101 will be described later in further details with reference to FIG. 2. When information other than EPG, such as a G-code, program information obtainable on the Internet, and an electronic fingerprint, is input, attribute information can be obtained from the signals (received broadcast signals) on the information. When attribute information is obtained from EPG, the acquisition unit 101 analyzes a program genre, a broadcast time and a channel, etc. from EPG that is extracted from a received broadcast signal by a slicer (not shown) to obtain information about a program. Then, the acquisition unit 101 further obtains attribute information corresponding to the obtained information about the program. For example, correspondence between information about a program (e.g., a title, a keyword contained in detail information) and attribute information may be determined in advance.

The storage unit 103 stores the correspondence between parameter information for displaying image and attribute information. In the present embodiment, an example of parallax stored as parameter information will be described. The storage unit 103 may be configured to store the range of view, the number of view points, or a amount of 3D reach, other than parallax. As the storage unit 103, HDD, CD-ROM, hard disk, memory card, ROM, punched card, or tape may be used, as long as it is capable of storing data. The storage unit 103 may also be accessible through network.

The selection unit 102 selects the parameter information stored in the storage unit 103. In the present embodiment, parameter information for converting parallax is sent to the generation unit 104.

The parameter information with the image content is supplied to the generation unit 104. The generation unit 104 generates a 3D image with a parallax which is adjusted based on the parameter information set by the selection unit 102. If the 3D image consists of two 2D images with different parallaxes, one or both of the parallaxes is adjusted. The 3D images may be generated from a 2D image supplied from an external device. In this case, the generation unit 104 estimates a value of depth from the 2D image and generates a plurality of images from different viewpoints with binocular parallax. In this case, the 3D images are generated in accordance with the parameter information set by the selection unit 102.

FIG. 2 shows an example of the correspondence between attribute information and parameter information that are stored in the storage unit 103. In the example of FIG. 2, a maximum parallax is set as parameter information. Program genres, broadcast times, and channels are elected as the attribute information in FIGS. 2(a), 2(b) and 2(c), respectively. The selection unit 102 selects parameter information (e.g., a maximum parallax) corresponding to attribute information extracted from EPG (e.g., genre, broadcast time, channel, etc.), referring to the storage unit 103.

FIG. 2(a) is a table showing the correspondence between program genres and parallax. For example, it is desirable to set the parallax low for programs mostly viewed by children, such as kids programs and educational programs. Because 3D effects have a greater impact on children's eyes than on adults', since the impact of 3D effects varies according to the distance between the eyes, and children's eyes are usually closer together than adults' eyes. FIG. 2(b) is a table showing the correspondence between broadcast time and parallax. It is known that the ability of the eyes to recover from eyestrain depends on the time of day. Usually, the ability is weak in the evening because the body is fatigue. Thus, it is desirable to set parallax low for evening programs. FIG. 2(c) is a table showing the correspondence between broadcast channel and parallax. Assuming that each channel tends toward a particular program genre, the correspondence between channel and parallax may be useful information.

Next, a method of setting parallax using maximum parallax as illustrated in FIG. 2 will be described. By way of example, a relative parallax for each pixel is stored in the storage unit 103. A pixel representing an image having a perceived depth equal to the distance between a viewer and a screen on which the image is displayed is zero parallax. Parallax of the other pixels consisting of the image is determined according to the distance from the reference pixel. Thus, pixels have each relative parallax. Hereafter, parallax in a positive value indicates a pixel representing a position back than the screen; parallax in a negative value indicates a pixel representing a position nearer to the viewer than the screen.

Maximum parallax indicates the limit of 3D reach of the image. For example, if a maximum parallax is 10, the parallax at the limit of 3D reach is −10, and the parallax at the limit of depth is +10. To set a maximum relative parallax as a maximum parallax, normalization is performed on the parallax of all the pixels consisting of the image. FIG. 3 shows an example of changes of parallax before and after normalization. In the example, the maximum parallax to be stored in the storage unit 103 is the same for both of the negative relative parallax and the positive relative parallax. However, the maximum parallax is not necessarily the same.

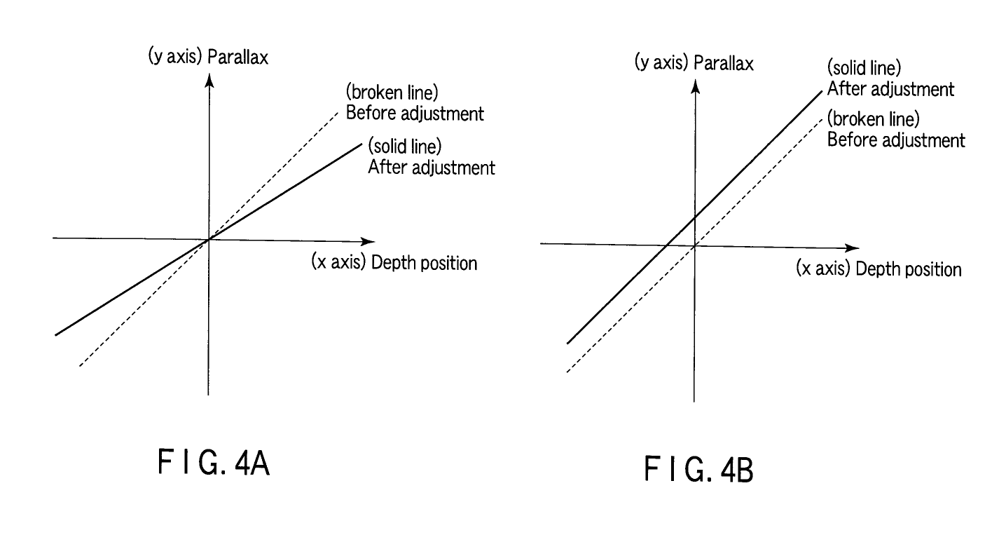

Information other than maximum parallax may be stored in the storage unit 103. FIG. 4 shows the parallax adjustment using a gain constant corresponding to the program information. A gain constant is a constant that multiplies with the parallax for each pixel. The gain constant extends or narrows the range of 3D reach. For example, the gain constant may be set to 1 or smaller for an evening program to reduce the range of 3D reach.

FIG. 4(b) shows the parallax adjustment using an offset corresponding to the program information. An offset is a constant added to the parallax for each pixel. The offset shifts the range of 3D reach backward or forward. For example, the convergence angle becomes small when a 3D reach recedes and large when it advances. There is evidence that a small convergence angle causes less eyestrain. For an evening program, the offset can be set to a positive value so that the 3D reach of each pixel recedes wholly.

It has been reported that eyestrain is caused by changing parallax frame by frame. It is desirable to adjust parallaxes by filtering frames in a time-direction after setting parallax per frame according to the parallax table in order to eliminate a pixel whose parallax greatly change frame by frame.

In the present embodiment, some examples of adjustment of stereoscopic effects using correspondence between program information and parallax have been described. However, the embodiment is not necessarily limited to those examples. Stereoscopic effects may be adjusted as needed, in accordance with, for example, an environment of viewing, a viewer, or vision characteristics of a viewer.

### Second Embodiment

The present embodiment describes an example of metadata embedded in an input signal. The embedded metadata indicates whether an image is allowed to be displayed three-dimensionally, or not (hereafter, the metadata is referred to as “rights management metadata”). An image can be displayed three-dimensionally with the approval of the copyright holder of a broadcast program by referring the rights management metadata, for example. An illustration of an image processing unit according to the present embodiment is omitted, as the image processing unit has the same structure as the image processing unit 100 shown in FIG. 1. A storage unit 103 is not necessarily provided.

An acquisition unit 101 acquires the rights management metadata. The rights management metadata indicates whether an image is allowed to be displayed three-dimensionally, or not.

A selection unit 102 sets parallax in accordance with the rights management metadata acquired by the acquisition unit 101. For example, if it is not allowed to display the image three-dimensionally, the parallax is set to zero.

A generation unit 104 sends a 2D image to a display unit 201 when the parallax is zero.

Here, the operation of the image processing unit 100 is described. When a broadcast signal is input, the acquisition unit 101 extracts the rights management metadata from EPG information that embedded the broadcast signal, and the selection unit 102 sets parallax for an image that is viewed from another view point based on the rights management metadata.

In the present embodiment, an example of using EPG information embedded in a broadcast signal to extract the rights management metadata was described, but other information may be used. For example, flag information embedded in a broadcast signal, program information obtainable for the Internet, or an electronic fingerprint may be used.

In the present embodiment, an example of the rights management metadata was described that indicates whether an image is displayed three-dimensionally or not. As information concerning a copyright of the image, information on 3D effects that is designated by a copyright holder may be used.

### Third Embodiment

According to the present embodiment, attribute information of a program is acquired by analyzing images of a broadcast program for a predetermined length of time, and a parallax is set based on the acquired attribute information. In this regard, the present embodiment is different from the forgoing embodiments. The image analysis begins, for example, when broadcast of a program starts and/or when a viewer changes a channel.

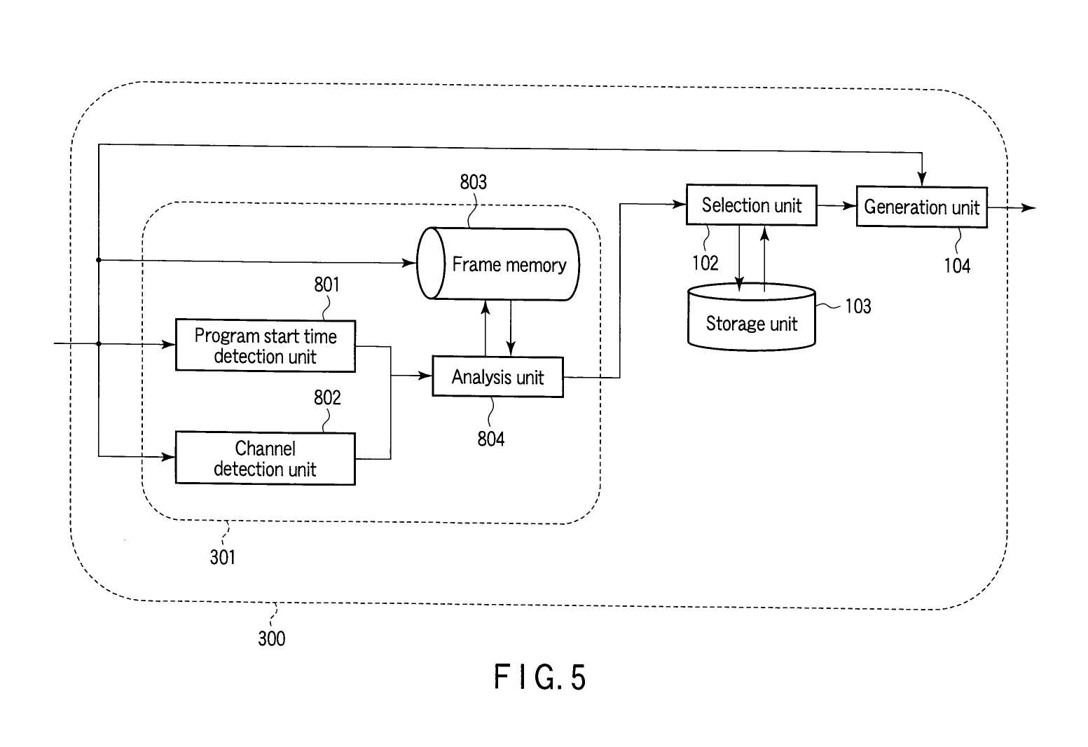

FIG. 5 is a block diagram of an image processing apparatus 300 according to the present embodiment. An acquisition unit 301 estimates a genre of a program being viewed by analyzing images of the program for a predetermined length of time.

The acquisition unit 301 includes a program start time detection unit 801 configured to detect a time when a broadcast program begins, a channel detection unit 802 configured to detect a time when a viewer changes a channel, a frame memory 803 configured to save images for a predetermined duration of time, and an analysis unit 804 configured to analyze attribute information of the broadcast program from the images saved in a predetermined number of frames.

The channel detection unit 802 detects a program start time, and/or a change of channel from input signals. The analysis unit 804 analyzes the images of the predetermined duration of time saved in the frame memory 803 to estimate attribute information of a broadcast program (e.g., genres). Then, a parallax is set to generate an image viewed from another viewpoint, referring to the table of parallax based on the estimated genre.

As an analysis method, there is a method of detecting an amount of characters embedded in images may be detected, for example. One of the findings reports that it is desirable to set parallax low for subtitles and captions. Accordingly, it is expected that parallax should be set low for a program which contains a considerable amount of characters.

In the present embodiment, an amount of characters embedded in images is used as subject information obtained from the result of analyzing the image. However, other subject information may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional (3D) image display apparatus, comprising:
an acquisition unit configured to acquire first attribute information related to attribute of one or more images to be displayed;
a selection unit configured to set parameter information based on the attribute information to control 3D effect for displaying the images, the parameter information includes at least parallax;
a generation unit configured to generate the images adjusted the 3D effect in accordance with the parameter information; and
a display unit configured to display the adjusted images.

2. The apparatus according to claim 1, wherein the selection unit comprises a storage unit configured to store the parameter information and the attribute information corresponding to the parameter information.

3. The apparatus according to claim 2, wherein the acquisition unit acquires second attribute information related to a program of the images to be displayed from broadcast signals, the second attribute information being included in the first attribute information.

4. The apparatus according to claim 3, wherein the acquisition unit acquires information of at least one of a broadcast time, a genre and a channel of the program, the at least one being included in the second attribute information.

5. The apparatus according to claim 1, wherein the acquisition unit acquires the first attribute information indicating whether the images should be displayed three-dimensionally or not, and
the selection unit sets the parameter information to display the images as a two-dimensional images when the first attribute information indicates not to display the images three-dimensionally.

6. The apparatus according to claim 5, wherein the generation unit further generates a signal to show a viewer that the images is not displayed three-dimensionally when the first attribute information indicates not to display the images three-dimensionally.

7. The apparatus according to claim 1, wherein the acquisition unit acquires the first attribute information of the images to be displayed by analyzing the images.

8. The apparatus according to claim 1, wherein the acquisition unit acquires the first attribute information by analyzing images for a predetermined duration of time when a program of the images starts and/or when a program that is being viewed is changed to another program.

9. The apparatus according to claim 1, wherein the generation unit generates a plurality of images with parallax from the images to be displayed in accordance with the parameter information.

10. An image processing apparatus, comprising:
an acquisition unit configured to acquire attribute information related to attribute of one or more images to be displayed;
a selection unit configured to set parameter information based on the attribute information to control 3D effect for displaying the images, the parameter information includes at least parallax; and
a generation unit configured to generate the images adjusted the 3D effect in accordance with the parameter information.
